(19) United States
(12) Patent Application Publication
(10) Pub. No.: US 2016/0175077 A1
(43) Pub. Date: Jun. 23, 2016

(54) ORTHODONTIC BLOCK WITH ORTHODONTIC AUXILIARY

(71) Applicant: Justin Parker, Salt Lake City, UT (US)

(72) Inventor: Justin Parker, Salt Lake City, UT (US)

(21) Appl. No.: 14/579,084

(22) Filed: Dec. 22, 2014

(51) Int. Cl. A61C 13/00; A61C 7/16; A61C 7/18; A61C 7/00; A61C 9/00

(52) U.S. Cl. CPC A61C 13/0022; A61C 7/002; A61C 9/0053; A61C 13/0019; A61C 7/18; A61C 7/16

(57) ABSTRACT

An orthodontic block milled or additively manufactured to create custom tooth born portions of an orthodontic appliance to hold or move teeth fitted with orthodontic auxiliaries, which attach to teeth and conform to the anatomy of a tooth/teeth and/or TADS, orthodontic appliances or other orthodontic hardware.

### RELATED APPLICATIONS

This application is a continuation-in-part patent application of Ser. No. 13/909,698, filed Jun. 4, 2013, entitled “Milling Block with Orthodontic Auxiliary”.

### BACKGROUND OF THE INVENTION

1. Field

This invention pertains to orthodontic anchoring and appliance attachment systems. Specifically, it refers to a milling block fitted with orthodontic auxiliaries such as buttons, cleats, tubes, brackets, springs, tad fastening clamps flex fit modules (FFM) or flex fit wafers (FFW) to better position and attach these auxiliaries to the exact anatomy of the: teeth within the mouth after milling to conform to the anatomy of a tooth/teeth and oral.

2. State of the Art

In Inside Dentistry, October 2012, Volume 8, Issue 10, published by AEGIS Communications, the article entitled “Evolution of Chairside CAD/CAM Dentistry” By Masly Harsono, DMD|James F. Simon, DDS, MEd James M. Stein, DMD|Gerard Kugel, DMD, MS, PhD traces the history Of computer aided manufacturing of orthodontic and dental appliances.

The use of computer-aided manufacturing computer-aided design (CAD/CAM) systems in dentistry was introduced in the mid-1980s, and has increased dramatically during the last decade, The first generation of CAD/CAM was designed to fabricate immediate chairside inlay and onlay ceramic restorations. Initial CAD/CAM technology results looked very promising, but they required an excessive amount of time for fabrication. This first generation of computer hardware and software offered a limited 2-dimensional (2D) view of the scanned images. The hard drive capacity was unable to store the large volume of data required for a 3-dimensional (3-D) view. The evolution of supportive computer technology over time has resulted in the chairside design and milling of complete crowns and multiple-unit ceramic restorations to a high standard. As a result. CAD/CAM scanning and milling systems have been a practical clinical reality, which makes it possible for the dental professional to produce chairside restorations.

The traditional method of making a dental impression with an elastic impression material can be alternatively performed with an intraoral digital scanner. This process is called the “optical impression,” Using either an optical laser or video digital technology, an intraoral digital impression-scanning and is used to capture complete detail of the teeth and supporting soft-tissue structures. A specialized 3-D rendering program permits the images of intraorally scanned optical impressions to be visualized in 3-D on the computer monitor in real time. The dental restoration design software offered by D4D Technologies (E4D Dentist System, D4D Technologies, www.e4dsky.com) and Sirona Dental Systems (CEREC® AC, Sirona Dental Systems, www.sirona.com) is more intuitive and user friendly fix the dental professional. These software programs come with features that allow dentists to mark the margins, digitally design virtual wax-up proposals of the restoration, place accurate occlusal contacts, and refine the proximal contact areas with the adjacent teeth. All of these tasks can be completed in minutes using the chairside design center before sending the final data to the computer-controlled milling unit. The following steps summarize the workflow: tooth preparation, intraoral scan, restoration design, milling of the ceramic monoblock, restoration finishing (coloring, glazing, polishing), and adhesive luting.

Simultaneously, there have occurred continual innovations in esthetic restorative materials. Monoblock ceramics can now withstand the stress of masticatory function as well as the damage introduced during the milling. The first-generation monoblocks made of feldspathic ceramic material have largely been replaced by reinforced ceramic with silica (feldspar, leucite, and lithium disilicate), non-silica (alumina and zirconia), and a combination of resin-ceramic-based materials resulting in a 3- to 11-fold increase in flexural strength. Factorial analysis of the variables influencing stress based on a computer simulation model showed that single thick monolithic all-ceramic crown materials performed better under stress compared to ceramic core material with veneering porcelain, aside from other influences. Furthermore, the coefficient of thermal expansion mismatch between core and veneer materials may initiate the internal stress that causes delaminating or internal cracking of porcelain.

The marginal fit of the milled ceramic restoration is an essential criterion for evaluating clinical success. Several investigators have evaluated the marginal fit of crown restorations fabricated with CAD systems. They reported an average marginal fit range from 25 to 113.88 μm. The authors' study showed that a user experienced with scanning who had completed three full training sessions produced restorations with significantly better-fitting margins than an inexperienced user who had completed a half-day training session and had no prior experience with the CAD system. Furthermore, the marginal/internal crown fit of laboratory-fabricated all-ceramic crowns showed the same accuracy as the CAD/CAM chairside, systems. A marginal gap up to 120 μm is considered to be clinically acceptable with a resin bonded luting agent, and a marginal gap up to 160 μm might be acceptable with regards to longevity although, theoretically, requirements of cementation films should be between 25 μm to 40 μm.

One concern about the ceramic block has been its monochromatic appearance. The early ceramic blocks for chairside milling were only available in limited shades. Dental professionals had to overcome this deficiency with external staining procedures. However, with the new advances in manufacturing technology, a greater selection of the blocks with esthetic qualities is available in the marketplace.

The polychromatic leucite-reinforced ceramic block (IPS Empress® Multi-block CAD, Ivoclar Vivadent, www.ivoclarvivadent.com) for E4D and CEREC systems has portioned cervical, body, and incisal segments. This block is incrementally graduated by chroma and value. This is done in an attempt to mimic the polychromatic effect of the natural dentition. The block's three ceramic segments can be portioned in the milled restoration by the design software in the restoration proposal stage.

The lithium-disilicate glass-ceramic block (IPS e.max® CAD, Ivoclar Vivadent) for the E4D and CEREC systems is now available in more values and shades, with nine high- and low-translucency blocks. Ivoclar has recently introduced its new lithium-disilicate blocks called Impulse. These blocks are available in three brightness values—V1, V2, and V3 along with two opalescent shades—Opal 1 and 2. The Opal blocks are designed mainly to create thin veneers and partial and single crowns.

The feldspar fine-particle ceramic blocks also come with two new products: Vitablocs® Triluxe Forte and Vitablocs® RealLife (Vita Zahnfabrik, www.vita-zahnfabrik.com). Currently, these two new ceramic blocks only can be used in the CEREC system. The Vitablocs Triluxe Forte contains a graded variation in color saturation with the middle layer (body) having a regular chroma; the top layer (enamel) having a low, less intense chroma with high translucency; and the lower layer (cervical) having the highest chroma and lowest translucency. This refined color gradation provides a smoother transition of color between layers that makes it possible to match the optical characteristics of natural tooth color, including translucency and color intensity.

The Vitablocs RealLife blocks have been created to mimic the tooth's natural enamel-layered-over-dentin design. They are especially appropriate for the restoration of anterior teeth, to make them look as much as possible like natural teeth. These blocks are designed to reproduce the shade effect in regard to translucency, chroma, and lightness by positioning the restoration to be milled within the spherical dome of dentin, which is surrounded by more translucent enamel.

A reinforced resin-ceramic block has also been recently introduced to the market. The Lava™ Ultimate CAD/CAM (3M ESPE, www.3mespe.com) for the CEREC system is a unique new resin-nano-ceramic material for which the company is claiming long-lasting esthetics and performance. The advantage of this block is that post-milling oven firing is not necessary. However, data on material wear properties are not yet available at this time.

Limited clinical data using these new innovative esthetic ceramic-reinforced blocks has been reported in the literature. Herrguth et al evaluated two types of crowns made by layered ceramic crown and monolithic CAD/CAM techniques on single anterior crown restorations. Both crowns were stained and glazed and evaluated by three independent examiners to assess the esthetic appearance. A scale of 1 to 6 was used, with 1 representing excellent characteristics and 3.5 marking the threshold of clinical acceptability. Regardless of me fabrication method, the crowns were esthetically acceptable in all 14 patients with no statistical difference between groups.

These rapid advances in ceramic monoblock technology have radically changed the performance and perceived esthetics of the restorations milled by the CAD/CAM chairside system. There are four chairside CAD systems currently available in the market for dental professionals—CEREC® AC, E4D Dentist™, Lava™ C.O.S., and the Cadent iTero™ (Cadent, www.cadentinc.com). Only two of these CAD systems, CEREC, AC and E4D Dentist, have the linked CAM system unit that can mill the restorations in 7 to 30 minutes depending on the size and complexity of the restoration. The material selection to be used is decided on a case-by-case basis. For esthetic reasons, dental professionals may choose a fine feldspar-particle glass ceramic or a leucite-reinforced glass ceramic. As mentioned above, they are available in layered blocks with improved esthetic options. There are reinforced resin-ceramics, which may be chosen for their low modulus properly and potential to decrease wear. These blocks do not require, an additional firing process, but the leucite material does gain strength with oven firing during the stain and glaze cycles. The lithium-disilicate ceramic might be able to better withstand posterior mastication forces.

CEREC AC by Sirona is the newest version of CEREC; the earliest versions have been available since the mid-1980s. The system not only has the ability to mill a ceramic single-unit chairside restoration, but it can also mill a temporary three-unit bridge out of an acrylic block. There is also a block that functions as a wax casting (burn-out block) for a cast-metal crown. Through Sirona's digital dental network, CEREC Connect, the optical impression can be sent out digitally by e-mail to the dental laboratory for fabrication of models, multiple units, bridges, implant abutments, and zirconium or metal crowns. It can also be integrated with Sirona's Galileos system to construct surgical guides for implant placement. Sirona's CEREC Biogenetic software can analyze the individual patient's occlusion and the anatomy of the adjacent teeth so that the restoration can be designed to be patient-specific. The recently released software version, 4.0, is more intuitive and user friendly.

E4D, made by D4D Technologies, has been available since December 2007. Clinically, the system does not require the application of a contrast agent (an aerosolized spray opaque powder) on the teeth to be scanned, and the scanning wand can make contact with the target. E4D Compass integrates 3-D data from a leading cone-beam digital system that is the corollary of the Gallieos system for implant surgical planning. With the release of version 2.0, E4D Dentist shares many of the above-mentioned features of the CEREC AC. The most significant shared feature is that both of these systems will be able to export their digital files in STL format, which is common to the stereolithography CAD data supported by many other 3D software packages, which are widely use in for rapid prototyping and CAM.

Based on the current information from Sirona, there are more than 11,000 CEREC users in the United States and 34,000 CEREC users internationally. This does not include the E4D systems. In addition, approximately 50 dental school in the United States use or have the CEREC or D4D CAD/CAM systems. Several dental schools have integrated the CAD/CAM technology into their pre-doctoral clinical curriculums. It has been estimated that by 2015, the number of CAD/CAM restorations—which includes crowns, bridges, veneers, and inlays—will be greater than 25% of the total units produced.”

Apex Dental Milling discusses zirconia as a post-and-core material, which began in 1993 when introduced by Meyenberg et al. The technique for milling a 1-piece zirconia post and core has been described by Awad and Marghalani and Streacker and Geissberger. Computer-aided design and computer-aided manufacturing (CAD/CAM) milled zirconia posts and cores can be used when esthetic demands are important, and when the anatomy of the root canal and/or the extensive loss of the coronal tooth portion requires the use of a custom post. This technique also allows the possibility of completing a post and core in the same appointment. As stated in various reports, this technique provides a post and core with greater toughness, maximal adaptability to the canal, and adequate esthetics.

Apex Dental Milling uses the Objet Eden260V 3D printer to turn digital impressions into solid dental models for dental and orthodontic clients. The Objet 3D printing system allows small and medium sized labs to take full advantage of the revolution in digital scanning with a fully automated and accurate process that reduces their cost-per-case, allows them to achieve higher output with less manpower and ultimately, compete with larger labs.

One preferred composition for milling is Zirconia. Zirconia, which is found as zirconium dioxide, is a white crystalline oxide that exists in three phases, cubic, tetragonal, and monoclinic, depending on temperature and pressure formation. The tetragonal and monoclinic forms are used in dentistry. Zirconia in the pure tetragonal phase is unstable. In order to create the milling blocks used in our machines, dental manufacturers add yittria, creating yittria-stabilized tetragonal polycrystals (Y-TZP). In this state zirconia is extremely hard and possesses a unique characteristic called transformation toughening. When tensile stress is introduced from crack propagation, the tetragonal formation morphs into monoclinic, increasing the volume 3 to 5%, and subsequently transforms the stress from tensile to compressive. This self-healing mechanism makes zirconia the ideal material for the oral environment.

Micro crack propagation is prevented while the monoclinic transformation occurs, thereby increasing surface tension and tensile strength (i.e.,—theoretically, grinding can increase the strength of Y-TZP zirconia). But before grinding-away on your crowns, you should observe certain criteria. The severity of grinding and the rise in temperature will affect the volume percentage of toughening. They recommend using fine-grade burs and copious amounts of water coolant to decrease heat generation. Researchers have studied the quality of diamond particles impregnated in dental burs, the hardness of the binding material, and the precision and centricity of the shafts, and have found that no one manufacturer has a superior product. All manufacturers agree that hydration and very light-to-no pressure is the best technique let the bur do the work and avoid dull tools. Also, the inside of a coping or monolithic restoration must be left untouched, it is recommended that if internal adjustments are needed for seating, the preparation should be adjusted.

A common question that arises about our TLZ all zirconia restorations concerns the wear effects they have on opposing dentition. There are many documented studies measuring the wear of zirconia against fluorapatite, porcelain, gold, lithium dicilicate, Lucite etc. These invitro studies can he summarized by focusing on particle size and finished surfaces. Zirconia is comprised of ultra-fine particles that do not become saw-tooth when roughened, unlike standard porcelains used in dental restorations. This characteristic evidently leads to low-wear of opposing enamel. A Study in J Adv Prosthodont 2010; 2;111-5 showed that wear to the antagonist teeth is much less than that of feldspathic porcelains. Moreover, the study agrees with many other studies we've reviewed, zirconia shows very low wear when highly polished.

Rella Christiansan's TRAC Research group has released preliminary results of a 7-year full-contour zirconia wear study which supports both of these claims. The study seeks to measure the amount of wear zirconia and other monolithic restorations exhibit in vivo. After one year, the “very promising” results show that zirconia “mimics” natural dentition.

As can be seen from the discussion above, the thrust of milling dentistry and orthodontics has been focused on fit, strength of materials, and color matching. There thus remains a need for a milling block fitted with integral orthodontic auxiliaries such as buttons, cleats, tubes, brackets, springs, tad fastening clamps flex fit modules (FFM) or flex fit wafers (FFW) to better position these auxiliaries within the mouth.

### SUMMARY OF THE INVENTION

Orthodontics and Dento-facial Orthopedics deal in treatments often using orthodontic tooth brackets of any type integrated directly with as fastener for the purpose directing tooth movement via brackets, aligners, springs, wires, and other devices directing forces for alignment. These brackets may not fit ideally to the anatomy of the teeth due to the averages on which they are fabricated and can misalign said brackets etc. in a direction which does not optimize the application of vectors applied to the tooth which requires compensatory adjustments, repositioning, or replacement of the orthodontic appliance.

The present invention comprises a metal or composite, ceramic or plastic block for milling, which incorporates a connected or attached orthodontic auxiliary, which would remain attached before during and after milling. Orthodontic auxiliaries as used herein comprise any orthodontic appliance or orthodontic appliance component which assists in the activation of said appliance or assists in the connectivity of one or more orthodontic appliances or connects and/or activates parts of said orthodontic appliances or assists in activating a tooth or teeth or jaws for the purpose of moving a tooth/teeth/jaws in the service of the profession of dento-facial orthopedics and/or orthodontics. Examples of orthodontic auxiliaries are fasteners, buttons, cleats, tubes, brackets, springs, tad fastening clamps, FFW or FFM clamps etc.

These milled blocks are adapted to be removably secured by a milling, machine for milling with connected orthodontic auxiliaries for milling to fit the anatomy of the tooth/teeth by obtaining a scan or impression of said tooth/teeth and allowing a custom design to better position/place orthodontic auxiliaries to said teeth. This system also allows for custom design of a bracket pad of any size or shape and partial or complete coverage of involved tooth. This coverage can be configured in a custom fashion to attain any amount of retentive qualities the orthodontist prefers. These optimized auxiliaries set a new standard in fit of orthodontic appliances using our appliances and better fit and strength of bonding to the anatomy of the dentition to the orthodontic corrective appliances. These auxiliaries could be a clamp which attaches to an appliance or a button, cleat, tube, bracket, spring, tad fastening clamp, FFW or FFM clamps.

Specifically, the invention comprises a milling block of any size and or shape or any material fitted with one or more orthodontic auxiliaries (button, cleat, tube, bracket, spring, tad fastening clamp, FFW or FFM clamps etc) placed at different angles on the milling block surfaces. These milling blocks are particularly suitable for in office milling and are adaptable to accept any available holding pin required by the milling machine. The milling block with the orthodontic attachment remains on the block before during and after custom milling.

The orthodontic attachment may be an actual attachment or may simply be a second smaller block on the milling block to allow for custom milling of the attachment. The larger block can be milled to fit the tooth and to provide the proper retentive features while the other block which may or may not be smaller would be milled into a bracket or any other orthodontic auxiliary programmed into the computer for milling. The orthodontic milling block can be milled to fit a portion or all of the anatomy of any tooth and any surface of a tooth in the human dentition replacing the bracket base pad or band or crown traditionally used to attach orthodontic appliances. The auxiliary milled out of the second block can be milled into a functioning bracket, cleat, tube, fastener or any other orthodontic equipment for the purpose of tooth stabilization or movement during orthodontic treatment or stabilization before or after orthodontic treatment.

In another variation, a block in which the band/bracket portion of an orthodontic appliance is attached to a tooth and the orthodontic auxiliary is milled within the block itself with nothing attached to it.

In still another variation, 3D printing or additive manufacturing (AM) may be employed to build up the block around an orthodontic appliance for attachment to custom fit attachment to a tooth or orthodontic auxiliary. Additive manufacturing refers to any of the various processes for printing a three-dimensional object. Primarily additive processes are used, in which successive layers of material are laid down under computer control. These objects can be of almost any shape or geometry, and are produced from a 3D model or other electronic data source. A 3D printer is a type of industrial robot.

The block may be created with a computer aided design package or via 3D scanner or data collection device (both referred to hereafter as 3D scanners) analyzing and collecting digital data as to the shape and appearance to fit a portion of all of the anatomy of any tooth and any surface of a tooth in the human dentition. Based on this data three-dimensional blocks of the scanned object can then be produced.

Before printing a 3D model of the orthodontic block, it must first be processed by software called a “slicer” which converts the model into a series of thin layers containing instructions tailored to a specific printer. The 3D printer follows the instructions to lay down successive layers of liquid, powder, paper or sheet material to build the orthodontic block from a series of cross sections. These layers, which correspond to the virtual cross sections from the CAD model, are joined or automatically fused to create the final shape forming a built-up orthodontic appliance or portion of an appliance, which follows the data and anatomy captured by the scanner of data collection device.

The 3D printer thus creates tooth born portions of the orthodontic appliance to be fit with orthodontic auxiliaries designed to connect to an orthodontic appliance or its associated components of an orthodontic system. This allows for the insertion of a fastener or connector to the tooth borne portion of the orthodontic appliance after additive manufacturing, or before where the finished fastener is placed into the 3D printer.

Some additive manufacturing techniques are capable of using multiple materials in the course of constructing pans. The present invention thus incorporates orthodontic auxiliaries into the built up block either as part of the additive manufacturing process or after it.

The invention thus provides a better fitting appliance tooth interface with an integrated auxiliary of any sort, serving a benefit to the patient with a more precise and custom orthodontic treatment.

### DESCRIPTION OF THE DRAWINGS

FIG. 1 is a perspective view of one preferred embodiment of the invention.

FIG. 2 is a perspective view of the embodiment of FIG. 1 with a different auxiliary alignment.

FIG. 3 is a perspective view of another preferred embodiment of the invention.

FIG. 4 is a perspective view of the embodiment of FIG. 3 with a different auxiliary alignment.

FIG. 5 is a perspective view of another preferred embodiment of the invention.

FIG. 6 is a perspective view of the embodiment of FIG. 5 with a different auxiliary alignment.

FIG. 7 is a perspective view of another preferred embodiment of the invention.

FIG. 8 is a perspective view of the embodiment of FIG. 7 with a different auxiliary alignment.

FIG. 9 is a perspective view of another preferred embodiment of the invention.

FIG. 10 is a perspective view of the embodiment of FIG. 9 with a different milling block alignment.

### DESCRIPTION OF THE ILLUSTRATED EMBODIMENT

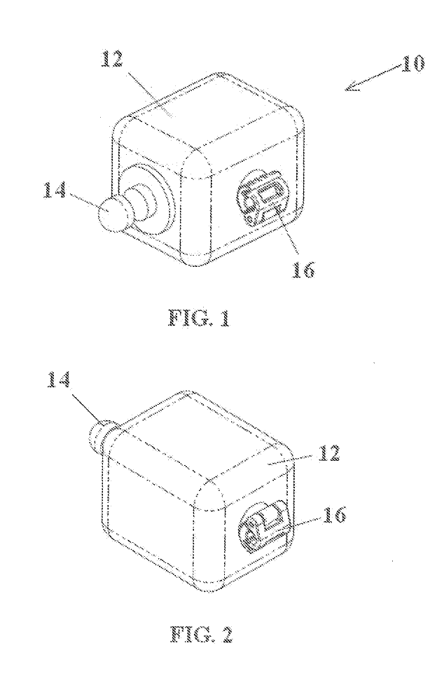

FIG. 1 is a perspective view of one preferred embodiment of the invention, 10. It comprises a metal or composite/ceramic block 12 attached to a holding pin 14 to bold the block 12 for milling. Incorporated into the block 12 is a connected orthodontic auxiliary 15 shown as a clamp 16 structured to bold onto curable resin rope. The attached clamp/auxiliary 16 is present before during and after milling to insure correct positioning of the milled piece when placed in the mouth.

FIG. 2 is a perspective view of the embodiment of FIG. 1 with a different auxiliary 15 alignment. The attachment of the camp/auxiliary 16 constructed at a 90 degree different facing orientation to meet the needs of a patient. Although FIG. 2 and the following drawings show the auxiliaries 15 and holding pins 14 in 90 degree off-sets, these auxiliaries 15 and holding pins 14 may be positioned and manufactured in any alignment required for orthodontic treatment.

These auxiliaries 15 could be a button 17, cleat 18, tube 19, bracket 20, spring 21, tad fastening clamp 22, FFW 23, or FFM clamps 24, etc. required to be positioned against or on the tooth as part of the orthodontic treatment.

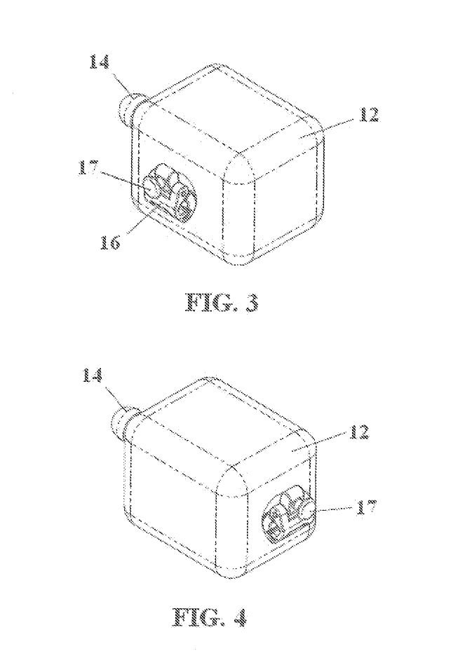

FIG. 3 is a perspective view of another preferred embodiment of the invention 10 with a metal or composite/ceramic block 12 attached to a holding pin 14 and a connected orthodontic auxiliary 15 shown as a combination clamp 16 and button 17.

FIG. 4 is a perspective view of the embodiment of FIG. 3 with a different auxiliary 15 alignment. The combination clamp 16 and button 17 is constructed at a different facing orientation to meet the needs of a patient.

FIG. 5 is a perspective view of another preferred embodiment of the invention with a metal or composite/ceramic block 12 attached to an optional holding pin 14 and connected to an orthodontic auxiliary 15 shown as a combination clamp 16, button 17, and tube 19. The holding pin 14 is omitted where the block 12 itself is structured to be held by the milling machine for milling without added structure.

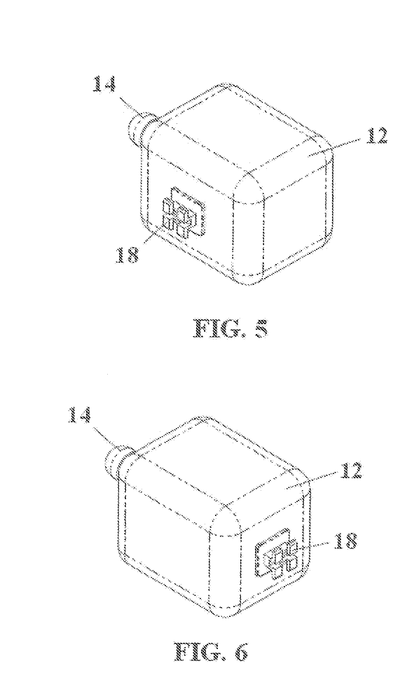

FIG. 6 is a perspective view of the embodiment of FIG. 5 with a different auxiliary alignment of the combination clamp 16, button 17, and tube 19.

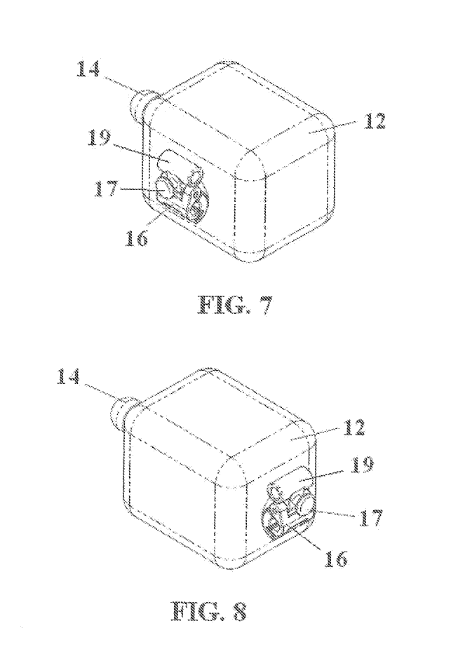

FIG. 7 is a perspective view of another preferred embodiment of the invention with a metal or composite/ceramic block 12 attached to a holding pin 15 and connected to an orthodontic auxiliary 15 shown as a button 17.

FIG. 8 is a perspective view of the embodiment of FIG. 7 with a different auxiliary 15 button 17 alignment.

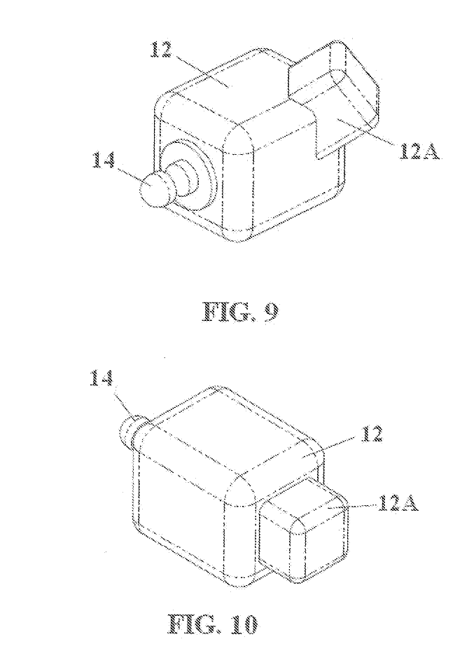

FIG. 9 is a perspective view of another preferred embodiment of the invention with metal or composite/ceramic block 12 attached to a holding pin 14 and connected to another off-set metal or composite/ceramic block 12A.

FIG. 10 is a perspective view of the embodiment of FIG. 9 with a different milling block 12A off-set alignment These milling blocks 12, 12A are constructed in various alignments for milling to provide a finished orthodontic device to meet the needs of a patient.

The composition of the block 12 is selected to meet the aesthetic color preferred by a user, as well as withstand the required stresses placed on the invention 10 during orthodontic treatment or mastication. Milling is accomplished with conventional milling machines, preferably computer controlled to fit the milled block to the scanned 3D contours of the tooth or mouth.

The milled block 12 is then placed within the mouth and the auxiliaries 16 connected with wires, resin ropes, etc. to secure the tooth/teeth in place for the duration of the orthodontic treatment. This avoids the need for brackets, which may not fit the actual contours of the tooth or mouth, or misalign the angle of the auxiliary to optimize the application of vector forces. The milled block 12 is also better fitting and more comfortable to the patient.

The holding pin 14 is usually removed after milling, but may be structured as an additional connector and retained after milling to serve as an additional auxiliary to connect to other button, cleat, tube bracket, spring, tad fastening clamp, FFW or FFM clamps etc.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

I claim:

1. An orthodontic block adapted to become an orthodontic auxiliary or appliance comprising:
a. a block capable of being altered by additive or subtractive shaping to create tooth born portions of an orthodontic system/appliance to hold or move teeth, and
b. one or more orthodontic auxiliaries, fasteners and connectors positioned onto the custom shaped block for connecting components of an orthodontic system/appliance to custom fit tooth borne portions of an orthodontic system/appliance for activation.

2. The orthodontic block according to claim 1, wherein the shaped block is adapted to attach to a tooth via bonding or mechanical attachment.

3. The orthodontic block according to claim 1, wherein the shaping comprises additive manufacturing employing:
i. a 3D scanner analyzing and collecting digital data of a shape, anatomy and appearance of an oral cavity to fit the anatomy of a tooth/teeth and surfaces of human dentition and oral structures,
ii. a CAD processor processing the digital data with slicing software converting the shape, anatomy, and appearance of the oral cavity into a series of thin layer instructions, and
iii. a 3D printer responding to the thin layer instructions by laying down successive corresponding layers of liquid, powder, paper or sheet material to build up the orthodontic block from a series of fused or joined cross sections to create its final shape.

4. The orthodontic block according to claim 1 wherein the shaping comprises milling employing:
i. an oral scanner analyzing and collecting digital data of a shape, anatomy, and appearance of human dentition and an oral cavity to fit the anatomy of a tooth/teeth and surface of human dentition and oral structures, and
ii. a milling machine capable of securing to the block to shape the block in accordance with the digital data to fit the anatomy of the tooth/teeth to position and place orthodontic auxiliaries.

5. The orthodontic block according to claim 1, wherein the orthodontic auxiliaries are placed and connected to the milled block on any of its surfaces and corners to allow for insertion onto a tooth/teeth in the oral cavity.

6. The orthodontic block according to claim 1, wherein the orthodontic auxiliaries remain on the block before, during, and after shaping.

7. The orthodontic block according to claim 1, wherein the orthodontic auxiliaries are affixed to the block after shaping.

8. The orthodontic block according to claim 1, wherein the orthodontic block includes one or more second blocks shaped to custom fit tooth borne portions of the second block to hold or move teeth.

9. The orthodontic block according to claim 8, wherein a fastener or auxiliary is shaped out of the second block to become a part of an orthodontic appliance.

10. The orthodontic block according to claim 8, including one or more orthodontic auxiliaries fitted onto the second blocks.
